(19) United States
(12) Patent Application Publication
(10) Pub. No.: US 2014/0095390 A1
(43) Pub. Date: Apr. 3, 2014

(54) MOBILE TRANSACTION APPROVALS

(71) Applicant: Oracle International Corporation, Redwood Shores, CA (US)

(72) Inventors: Louis Y. LEI, San Leandro, CA (US); Frederic PORTAL, Pleasanton, CA (US); Amira A. MORCOS, San Ramon, CA (US); Bhupinder Singh SONDHI, Fremont, CA (US)

(73) Assignee: Oracle International Corporation, Redwood Shores, CA (US)

(21) Appl. No.: 14/038,737

(22) Filed: Sep. 26, 2013

Related U.S. Application Data
(60) Provisional application No. 61/707,272, filed on Sep. 28, 2012.
(60) Provisional application No. 61/780,710, filed on Mar. 13, 2013.

(51) Int. Cl. G06Q 20/32

(52) U.S. Cl. CPC G06Q 20/322
USPC 705/44

(57) ABSTRACT

A method, system, and computer program product for delivery of enterprise application data to users. Processing commences by identifying an enterprise application running on a server (e.g., an application server) for which approval processing is to be performed to approve transactions pertaining to the enterprise application. Further processing aggregates groups of transactions, and generates transaction approval display data (e.g., for display screens) that can be displayed on a mobile device (e.g., a smartphone, a mobile terminal, etc.). A sending module participates in sending the transaction approval display data to the mobile device, after which a mobile user performs approvals (e.g., singly or in groups), and transmits data back to (e.g., as an approval or as a disapproval or both). The approvals or disapprovals responsive to the displayed transaction approval display data are processed (e.g., as approvals or as disapprovals or both) for retrieval by the enterprise application.

### RELATED APPLICATIONS

The present application claims the benefit of priority to U.S. Provisional Patent Application Ser. No. 61/707,272, entitled “METHOD AND SYSTEM FOR IMPLEMENTING MOBILE TRANSACTION APPROVAL” (Attorney Docket No. ORA130349-US-PSP), filed Sep. 28, 2012; and the present application claims the benefit of priority to U.S. Provisional Patent Application Ser. No. 61/780,710, entitled “METHOD AND SYSTEM FOR IMPLEMENTING MOBILE TRANSACTION APPROVAL” (Attorney Docket No. ORA130349-US-PSP-1), filed Mar. 13, 2013, both of which are hereby incorporated by reference in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosure relates to the field of delivery of enterprise application data to users and more particularly to techniques for aggregating and delivering transaction approvals to mobile terminals.

### BACKGROUND

Many businesses and other organizations use software applications and/or suites of such applications to organize the organization's business affairs, track business performance, manage employee data, and perform functions for managing the enterprise. These “enterprise applications” are often quite complex, relying on numerous database tables to store and manage data covering a wide range of aspects of an organization's business. Moreover, functions to manage an enterprise are often partitioned into multiple enterprise applications, where each application serves one particular function (e.g., purchase order management, accounts payable management, etc.).

One particular aspect of such enterprise applications is known as “management approvals”, and a management approval process is frequently present as a feature of any or all of these enterprise applications. Management approvals are used, for example, to provide approval processing for transaction types such as expense reports, purchase orders, vouchers, and other types of transactions that require progression through an approvals process.

Conventional systems do not aggregate approvals when transactions needing approval span across multiple transaction types. For example, in a conventional system, if a user needs to approve an expense report, and also needs to approve a voucher, the user would need to first access an “Expense Report” application and then would need to access a “Voucher” application. This leads to an inordinate amount of time spent context-switching between applications, and leads to egregious inefficiencies when multiple transactions need to be approved. Moreover, conventional systems rely on desktop-borne interfaces when performing the approval processing.

What is needed is a technique or techniques to perform approvals across differing transaction types, and furthermore to perform approvals on groups of transactions and to display groups of transactions on any suitable platform, including mobile devices.

### SUMMARY

The present disclosure provides an improved method, system, and computer program product suited to address the aforementioned issues with legacy approaches. More specifically, the present disclosure provides a detailed description of techniques used in methods, systems, and computer program products for aggregating and delivering transaction approvals to mobile terminals.

Processing is initiated by identifying an enterprise application running on a server (e.g., an application server) for which approval processing is to be performed to approve transactions pertaining to the enterprise application. Further processing aggregates groups of transactions, and generates transaction approval display data (e.g., for display screens) that can be displayed on a mobile device (e.g., a smartphone, a mobile terminal, etc.). A sending module participates in sending the transaction approval display data to the mobile device, after which a mobile user performs approvals (e.g., singly or in groups), and transmits data back to (e.g., as an approval or as a disapproval or both). The approvals or disapprovals responsive to the displayed transaction approval display data are processed (e.g., as approvals or as disapprovals or both) for retrieval by the enterprise application.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1 depicts a system for processing aggregated transaction approvals using mobile terminals, according to some embodiments.

FIG. 2A depicts a flow chart of an approach to approval processing, according to some embodiments.

FIG. 2B is a block diagram of an example user interface logic partitioning as used in systems for processing aggregated transaction approvals using mobile terminals, according to some embodiments.

FIG. 3 depicts a block diagram of a client-server model with plug-in data handlers as used in systems for processing aggregated transaction approvals using mobile terminals, according to some embodiments.

FIG. 4 presents a screen including a list of transaction types used in systems for processing aggregated transaction approvals using mobile terminals, according to some embodiments.

FIG. 5 is a diagrammatic representation of an entity hierarchy as used in systems for processing aggregated transaction approvals using mobile terminals, according to some embodiments.

FIG. 6 is a screen shot of a home screen as used in systems for processing aggregated transaction approvals using mobile terminals, according to some embodiments.

FIG. 7A depicts transaction approval display data displayed as a transaction approval interface as used in systems for processing aggregated transaction approvals using mobile terminals, according to some embodiments.

FIG. 7B is a screen shot of an approvals list interface including a mass approval interface as used in systems for processing aggregated transaction approvals using mobile terminals, according to some embodiments.

FIG. 8 is a screen shot of an approvable item detail interface as used in systems for processing aggregated transaction approvals using mobile terminals, according to some embodiments.

FIG. 9 is a screen shot of an approval submission interface as used in systems for processing aggregated transaction approvals using mobile terminals, according to some embodiments.

FIG. 10 is a block diagram of a system for processing aggregated transaction approvals using mobile terminals, according to some embodiments.

FIG. 11 is a block diagram of a system for processing aggregated transaction approvals using mobile terminals, according to some embodiments.

FIG. 12 is a block diagram of a system for processing aggregated transaction approvals using mobile terminals, according to some embodiments.

FIG. 13 depicts a block diagram of an instance of a computer system suitable for implementing an embodiment of the present disclosure.

### DETAILED DESCRIPTION

Some embodiments of the present disclosure address the problem of aggregating transaction approvals from multiple applications. More particularly, disclosed herein and in the accompanying figures are exemplary environments, methods, and systems for aggregating and delivering transaction approvals to mobile terminals.

### OVERVIEW

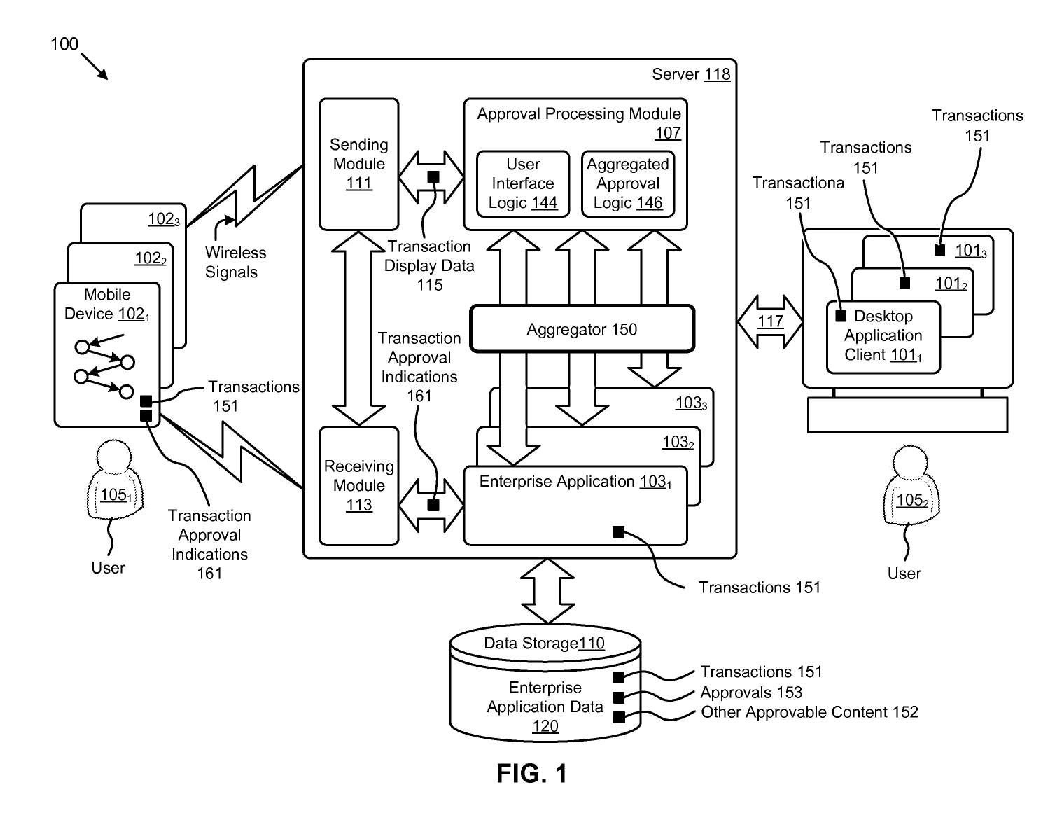

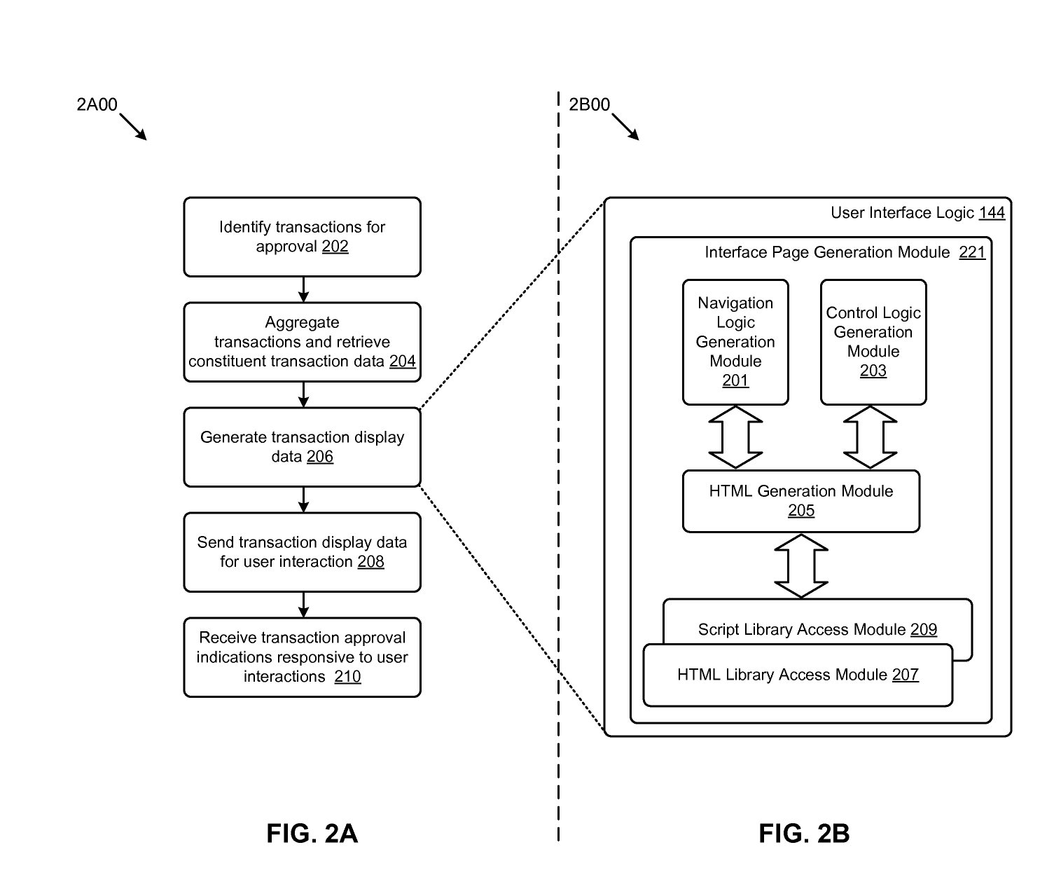

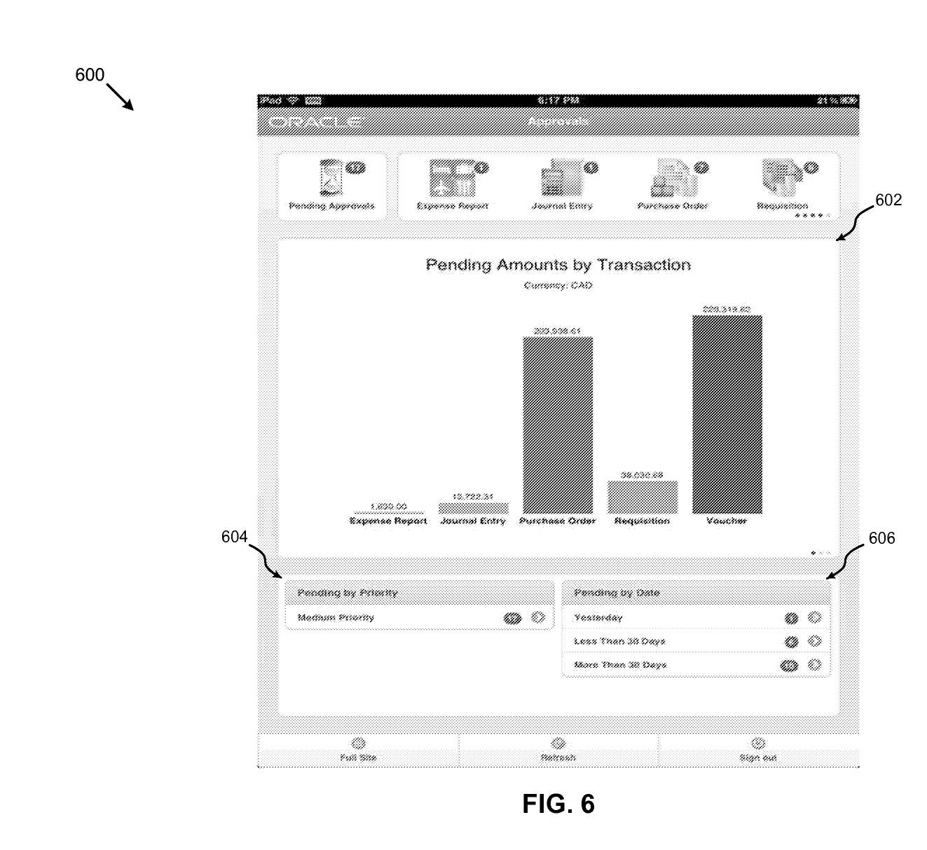

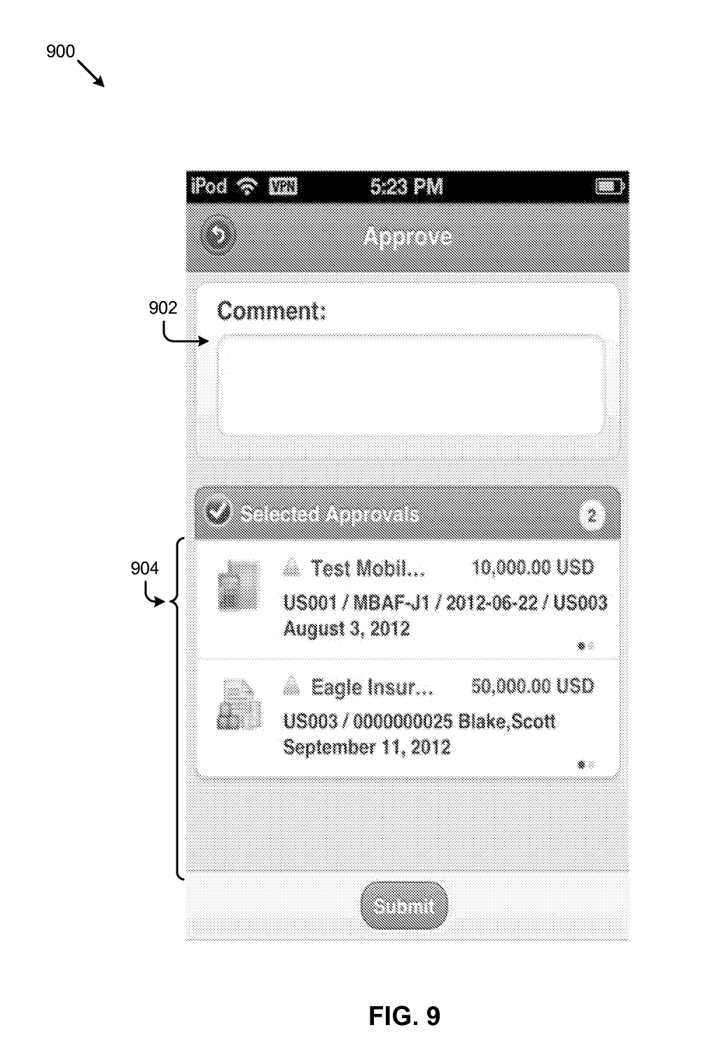

In describing techniques to address aggregating and delivering transaction approvals to mobile terminals, an environment is described (e.g., see FIG. 1). Constituent components within such an environment include several enterprise applications, various processing modules to aggregate transaction across multiple enterprise applications (e.g., see FIG. 2A), some user interface logic (see FIG. 2B), and some way to display aggregated transactions to a user (e.g., see FIG. 6 through FIG. FIG. 9) for user approvals which are then marked as approved in a database.

### DEFINITIONS

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

Reference is now made in detail to certain embodiments. The disclosed embodiments are not intended to be limiting of the claims.

### DESCRIPTIONS OF EXEMPLARY EMBODIMENTS

FIG. 1 depicts a system 100 for processing aggregated transaction approvals using mobile terminals. As an option, one or more instances of system 100 or any aspect thereof may be implemented in the context of the architecture and functionality of the embodiments described herein. Also, the system 100 or any aspect thereof may be implemented in any desired environment.

As shown, system 100 is operated by one or more users (e.g., user 105₁, user 105₂) via one or more desktop applications 101 (e.g., desktop application 101₁, desktop application 101₂, application 101₃ etc.), and/or one or more mobile phone or tablet mobile devices (e.g., mobile device 102₁, mobile device 102₂, etc.). Using desktop or mobile terminals, the users operate the system to access and utilize enterprise applications (e.g., enterprise application 103₁, enterprise application 103₂, enterprise application 103₃, etc.) hosted on a server 118. Such user interactions can be communicated over wireless signals or over network 117, and such user interactions serve to initiate and/or perform any activities or functions offered by the server 118 and/or offered by the enterprise applications such as approval of transactions.

User interaction may originate from any type of computing platform that may be used to operate or interface with a server 118. Examples of such computing platforms include for example, workstations, personal computers, laptop computers, or remote computing terminals. Mobile devices 102 comprise any type of a portable tablet device, including for example, tablet computers, portable readers, etc. Mobile telephone devices comprise any mobile device that can suitably access an application on server 118, such as smartphones and programmable mobile handsets. It is noted that practice of the techniques disclosed herein is not limited in its application to just these types of devices. The various disclosed embodiments are applicable to any computing device that works in conjunction with an enterprise application.

Exemplary desktop or mobile terminals comprise a display device, such as a display monitor or screen for displaying scheduling data and other interface elements to users. Further, desktop or mobile terminals may also comprise one or more input devices for the user to provide operational control over the activities of the enterprise applications. Such input devices can be implemented in the form of a mouse, a touch screen, a keypad, or keyboard or combinations of the foregoing.

Exemplary enterprise applications can include supply chain management (SCM) applications that manage raw materials, work-in-process and/or finished products, and coordinate with suppliers; customer relations management (CRM) applications that are used to track, store and/or manage customer information; financial applications that track and/or analyze the financial performance of the organization, and/or human resources applications that provide management of the human resources functions of the organization, and/or other applications. In some cases, these applications are standalone applications. In other cases, a single business application or suite of applications might provide some or all of such functionalities using any number of interface screens.

The data accessed or created by the enterprise applications (e.g., transactions 151, approvals 153, other approvable content 152, other instances of enterprise application data 120, etc.) can be stored in a data storage unit (e.g., data storage 110). The data storage 110 can be implemented using any type of computer readable mediums or storage devices. The computer readable storage devices comprise any combination of hardware and software that allows for ready access to the data within data storage 110. For example, the computer readable storage device can be implemented as computer memory or disk drives operatively managed by an operating system. The aforementioned transactions 151 or other approvable content 152 can be accessed by the enterprise applications and/or from the aggregator 150. In some cases the aggregator can access transactions 151 or other approvable content 152 directly from the data storage 110 (e.g., without traversing the enterprise applications). The aggregator serves to aggregate transactions for delivery to the approval processing module 107, which in turn uses a sending module 111 to communicate mobile devices (e.g., mobile device 102₁, mobile device 102₂, mobile device 102₃, etc.).

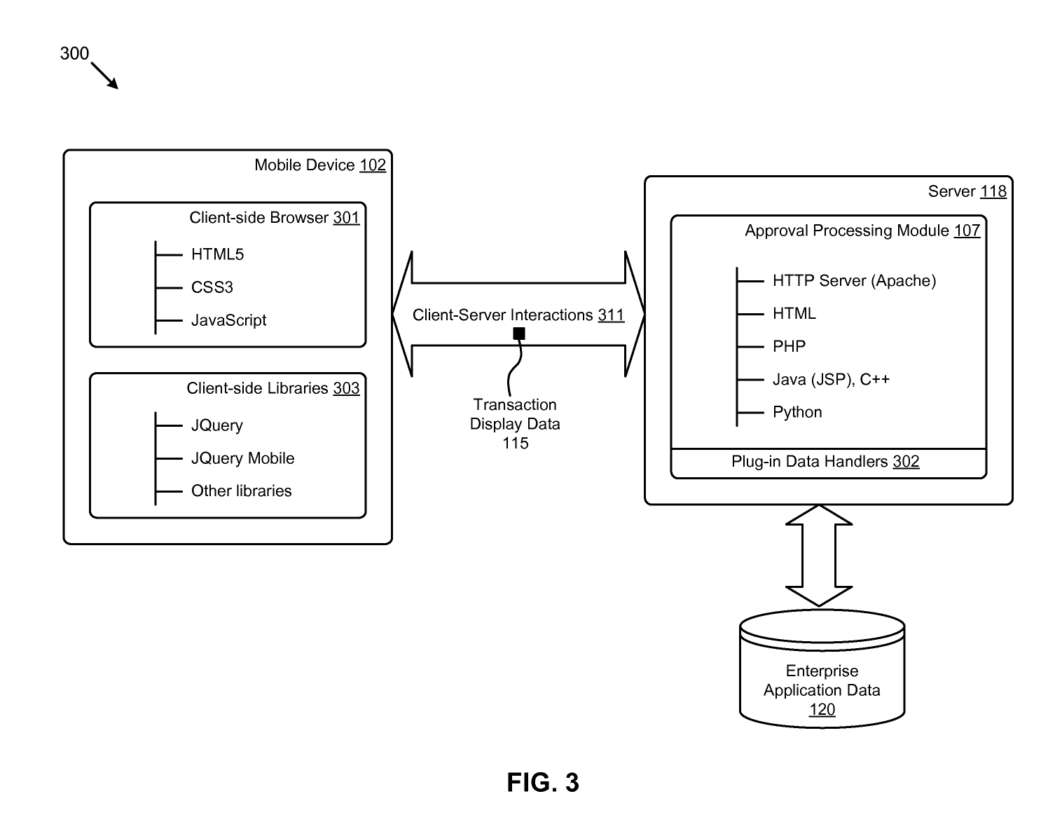

As shown, an approval processing module 107 is provided on the server 118 and comprises two application packages that comprise one or more instances of user interface logic 144 and aggregated approval logic 146, respectively. The user interface logic 144 can include HTML generation for screen device display and for navigation within and between display screens (e.g., see FIG. 2B). The aggregated approval logic implements aggregated approvals. In some embodiments (see FIG. 3) the approval processing module implements a data model and plug-in interface to provide access to functions of the approval processing module by using plug-in data handlers. Using the data handling schemes as heretofore described, transaction data can be aggregated (e.g., via the enterprise applications, or retrieved directly from the data storage). The approval processing module can format transaction display data 115 to deliver to workstations and/or mobile devices for user interaction and approvals for the transactions. As shown in the system of FIG. 1, delivery of screens (e.g., transaction display data 115) and receipt of user interactions (e.g., transaction approval indications 161) between the approval processing module and the mobile terminals are facilitated by a sending module 111 and a receiving module 113, which receiving module or other module receives signals in response to a user interaction with the transaction approval display data. The foregoing describes one possible embodiment, though other flows and interactions and protocols are possible. Strictly as one example, an approach to approval processing can be implemented as a flow of operations, which is discussed as follows.

FIG. 2A depicts a flow chart of an approach to approval processing 2A00. As an option, one or more instances of approval processing 2A00 or any aspect thereof may be implemented in the context of the architecture and functionality of the embodiments described herein. Also, the approval processing 2A00 or any aspect thereof may be implemented in any desired environment.

As shown, the approval processing commences at an operation 202 to identify transactions that are pending approval. Such transactions can originate from a particular enterprise application, or they can be aggregated from a plurality of enterprise applications, or they can originate from stored transactions 151 in data storage 110. In one exemplary case, the aggregator or other module is configured to search one or more database structures (e.g., database structures in data storage 110) to identify one or more transactions for which approvals are needed by a reviewer (e.g., a user). Specific search criteria may be used to identify and aggregate pending transactions. For example, the search for pending transactions can be performed based upon specific users, reviewers, departments, groups, and/or any other suitable search criteria, which search results in a set or sets of identified transactions.

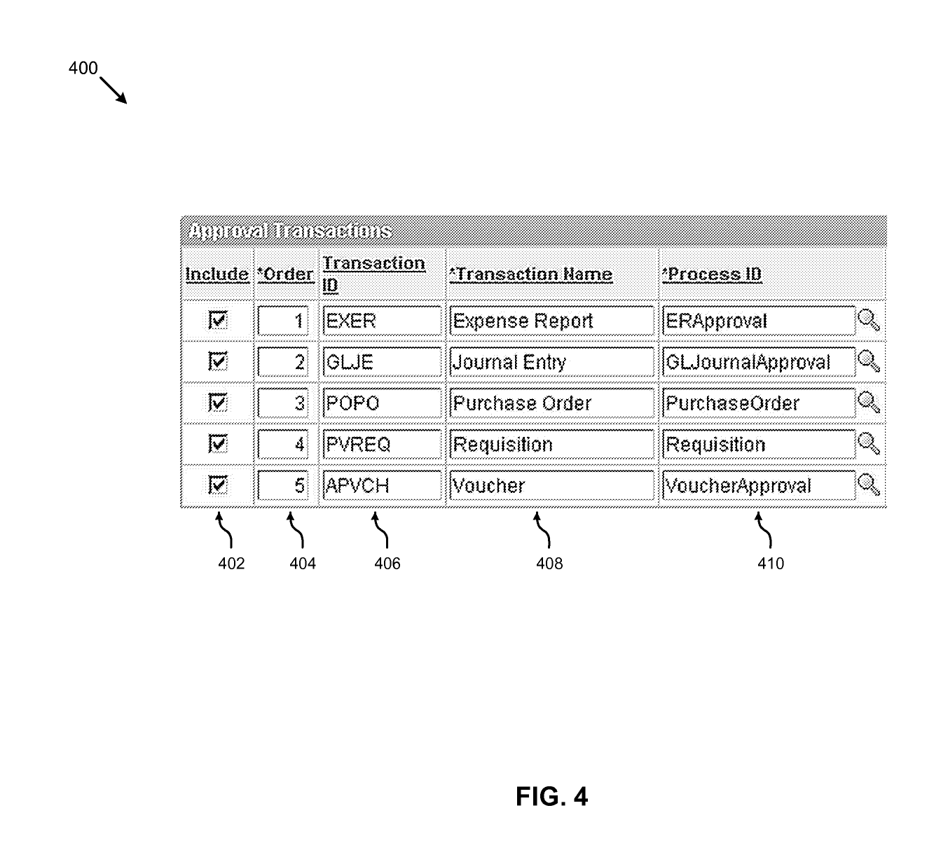

The operation 204 aggregates the identified transactions and retrieves constituent transaction data (e.g., any one or more of the identified transactions are retrieved from underlying database structures). The identified transactions can be aggregated together. Such aggregation can occur even if the identified transactions are not uniformly of a common type of transaction. For example, the transactions may pertain to expense reports, journal entries, purchase orders, requisitions, and/or voucher transactions (see FIG. 4 for a sample of types of transactions). Even though these transactions are of different types, they can nevertheless be aggregated. In some embodiments, settings can be configured to control which individual ones from a set of retrieved transactions are to be aggregated together. Further, settings can be configured to control the order in which individual ones from a set of retrieved transactions are to be displayed.

The operation 206 serves to generate interface pages and display transaction data for approvals. The interface pages (e.g., see FIG. 6 through FIG. 9) include displayable elements pertaining to the aggregated transactions that are pending approval. The interface pages also include interface elements to display information pertaining to the transactions, and displayable elements for use by reviewers to approve the transactions (e.g., singly or in groups). The transaction display data may be displayed on any suitable device. In some embodiments, the display data is configured using HTML such that it can efficiently and effectively be displayed and utilized on a mobile device that implements an HTML browser (e.g., see FIG. 2B).

At operation 208, the transaction display data is sent (e.g., using sending module 111) to the appropriate device to be accessed by a user. The display mechanism at the user device (e.g., browser or display processor) parses the transaction display data and displays the pages to the user. For example, if the transaction display data incorporates HTML5, then an HTML5 browser at the user device processes the sent HTML5 data to generate display images. The device can also accept user inputs to send control signals (e.g., transaction approval indications 161) back to the server to process the user interactions (e.g., to indicate approval of a group of transactions from the mobile device).

A server receives transaction approval indications responsive to user interactions; see operation 210.

As earlier indicated, HTML for codifying interface pages, and for codifying the display transaction data for approvals, are generated and sent to the user. Such interface pages can include navigation controls, and can implement logic between the mobile device and server (e.g., using PHP, Java Server Pages, Python, etc.). For example, user interface logic can be partitioned into modules for navigation logic, HTML generation, and one or more modules for HTML library access.

FIG. 2B is a block diagram of an example user interface logic partitioning 2B00 as used in systems for processing aggregated transaction approvals using mobile terminals. As an option, one or more instances of user interface logic partitioning 2B00 or any aspect thereof may be implemented in the context of the architecture and functionality of the embodiments described herein. Also, the user interface logic partitioning 2B00 or any aspect thereof may be implemented in any desired environment.

As shown, an interface page generation module 221 subsumes the navigation logic generation module 201 and the control logic generation module 203. Each of the aforementioned modules serve to host or interact with an HTML generation module 205, which in turn interacts with an HTML library via one or more library access modules (e.g., HTML library access module 207 and/or script library access module 209).

The foregoing examples of libraries and library access modules are purely illustrative. Other libraries can be used, and/or access to subroutines (e.g., in C or C++ or C#) or classes (e.g., Java classes) and/or scripts (e.g., in JavaScript) can be facilitated by a library access module. Further, the HTML generation module 205 can access display-centric facilities such as cascaded style sheets (e.g., CSS, or CSS3, etc.).

FIG. 3 depicts a block diagram of a client-server model 300 with plug-in data handlers 302 as used in systems for processing aggregated transaction approvals using mobile terminals.

Returning to the flow of operations shown and described in FIG. 1 and FIG. 2, the approval processing module 107 generates transaction display data 115 that is sent from the server 118 to user devices (e.g., using a sending module 111, or using a network 117). The display data (e.g., pages and/or transaction display data) is generated in a format that is displayable at these devices.

In some embodiments, an environment for page generation and logic processing is provided in the form of a framework. FIG. 3 illustrates an approach that can be implemented to provide a framework for displays and for interactions between a client and a server.

On the client side (e.g., the shown mobile device 102), a client-side browser 301 is used to display a user interface. User actions are processed, and in exemplary cases the processing includes communicating (e.g., in the form of client-server interactions) commands for querying and for approving pending transactions. The display data may be implemented using HTML5, CSS3, and/or JavaScript. Further, various libraries (e.g., client-side libraries 303) may be utilized to implement user and/or client-server interactions 311. Examples of such libraries include JQuery, JQuery Mobile, etc. In certain embodiments, a client-server interface such as the common gateway interface (CGI) can be used in conjunction with java servlets to allow access to resources on the server. As yet another example, scripts (e.g., Oracle iScripts) can be used to access URL identifiable resources.

On the server side, the approval processing module 107 implements interface logic including navigation logic generation, control logic generation, and HTML generation (e.g., see FIG. 2B). Such generation modules can be implemented using packages that are shared by any type of client and any type of transaction.

As shown, and as earlier indicated, the approval processing module implements a data model and plug-in interface to provide access to functions of the approval processing module by using plug-in data handlers 302. The plug-in data handlers 302 serve to retrieve (e.g., from data storage) or otherwise access (e.g., via an interface to enterprise applications 103) transaction data and data constituent to transactions. In some embodiments, helper classes are used to maintain mappings between each approval item, its handler, its related images, and any corresponding transaction definitions. For example, mappings can be created using a configuration file or a configuration relation, possibly also using a configuration graphical user interface. As a specific case, to configure a particular transaction, the following steps are performed:
Create a set of icon images for the particular transaction.
Create one or more processes to implement one or more data handlers (e.g., Java methods) for the particular transaction, possibly implementing one or more classes (e.g., Java classes).
Establish the correspondence between the particular transaction and its icon and classes.

The aforementioned particular transactions can be any one or more of any transaction types supported by system 100. Some examples of possible transaction types are hereunder discussed.

FIG. 4 presents a screen including a list of transaction types 400 used in systems for processing aggregated transaction approvals using mobile terminals. The transaction types 400 or any aspects thereto may be implemented in any desired environment.

The shown list includes:
“Expense Report” type transactions.
“Journal Entry” type transactions.
“Purchase Order” type transactions.
“Requisition” type transactions.
“Voucher” type transactions.

The shown transaction types are purely examples and other transaction types are possible.

The screen of FIG. 4 is used to configure a particular transaction type for use in mobile approvals. The following list describes configuration of such fields:
Include Indication 402. A check marks an indication to include in a mobile approval regime (e.g., this check mark indication is retrieved by an aggregator 150 and/or an approval processing module 107).
Display Order Indication 404. The shown numeric value specifies an order in which to display the transactions.
Transaction ID 406. A code handle with which to identify a transaction type.
Transaction Name 408. A short description of the transaction type. Such a description or name can be used in any one or more displays.
Process ID 410. This field encodes a process name or other value that identifies a process that will be used to perform the approval process of the transaction in the backend. The corresponding process might be set up in a registry accessible by server 118.

Extensions to the screen of FIG. 4 are possible, and additional configuration can be accomplished. Strictly as examples, an additional configuration screen (not shown) can serve to configure the following data items:
Transaction Handler Class. The full path of the handler class name.
Large Image. The image used in certain display pages. It can be specified as either a URL or as a name (e.g., file name, object name) of the image object.
Small Image. The image used in certain display pages. It can be specified as either a URL or as a name (e.g., file name, object name) of the image object.

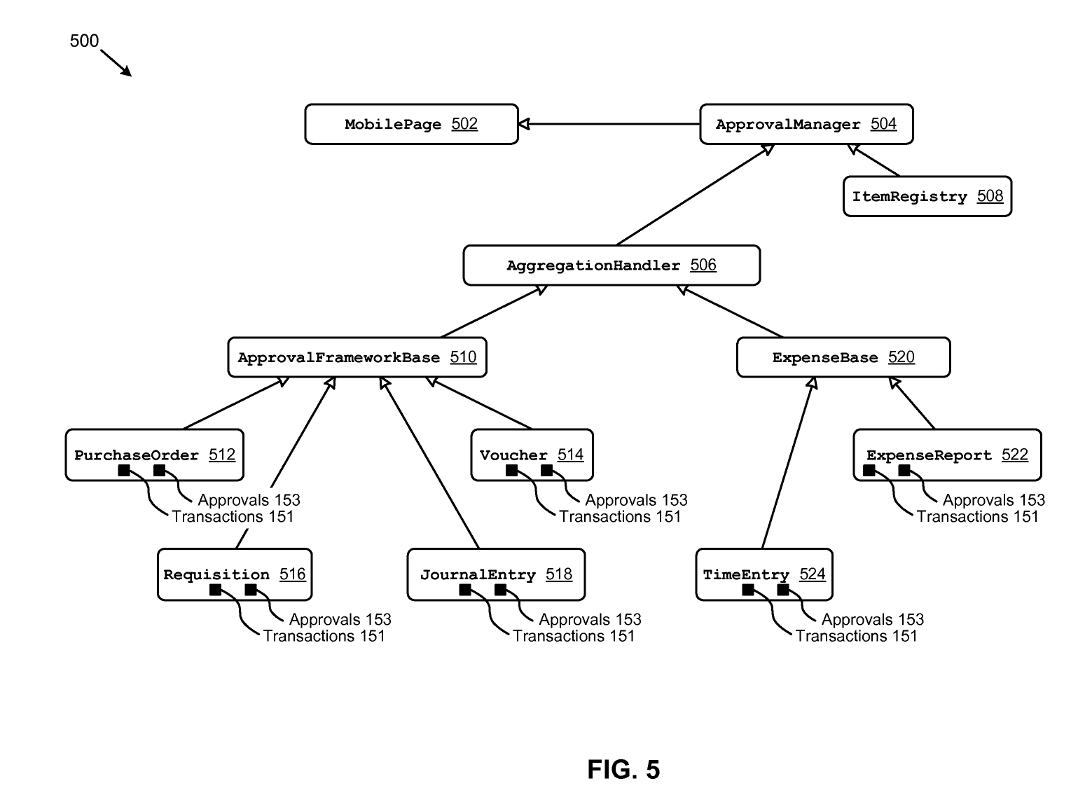

FIG. 5 is a diagrammatic representation of an entity hierarchy 500 as used in systems for processing aggregated transaction approvals using mobile terminals.

The diagrammatic representation of FIG. 5 depicts an example hierarchy of entities and objects according to some embodiments. The shown entities can map to processes or classes or schema objects. Strictly as an example, and in accordance with the particular entity hierarchy 500, when user accesses the user interface, a MobilePage 502 is created and interacts with the ApprovalManager 504. The approval manager uses an ItemRegistry 508 to map the transaction to its data handler, then interacts with one or more of the mapped data handlers (e.g., PurchaseOrder 512, Requisition 516, ExpenseReport 522) as required to retrieve and/or process the data. Each data handler implements a common interface AggregationHandler 506 that is used by an ApprovalManager.

In exemplary operation, instances of the handler interface return a count for the pending approval items. In addition, the handler interface supports a method to return a list of items to be approved. The handler can also return constituent data for any one or more of the items to be approved.

In some embodiments, an object class is used to represent the approval items, and object class can associate various properties with a particular aspect of an approval item. Properties can be processed by a common framework, and properties and their values can be passed individually (or in groups) on demand. Further, the data to be displayed together with a particular approval item can be passed in any format.

Approval items can have any granularity, including a line item granularity for approval (e.g., a line item in a purchase order). Any level of granularity of any form of an approval item can be represented as objects. In addition, attachments may be specified to correspond to any of the approval items. For example, an image of a receipt corresponding to a line item in an expense report can be attached. In one alternative, a URL can be passed to provide a location/representation of such an image or other object.

The entity hierarchy 500 or variations thereof support a wide variety of correspondences and operations that can be applied to one or more entities and/or instances of such entities. Strictly as examples, various operations (e.g., filtering, aggregation, ordering, etc.) can be applied to the transactions 151 or other data items in the hierarchy such that:
Transactions are identified based upon at least one of specific users, reviewers, departments, or groups.
A group of transactions pending approval are aggregated together.
Transactions are identified based upon a particular transaction type.
Transactions are ordered based upon an order indication or date or priority (e.g., see FIG. 6).
Approvals 153 correspond to transactions 151 for at least one of purchase orders (e.g., see PurchaseOrder 512), vouchers (e.g., see Voucher 514), requisitions (e.g., see Requisition 516), journal entries (e.g., see JournalEntry 518), expense reports (e.g., see ExpenseReport 522), and/or time entries (e.g., see TimeEntry 524).

Some embodiments can include variations in the entity hierarchy, and variations in semantics and inheritance might correspond with the variations in the entity hierarchy. An exemplary entity hierarchy includes the following organization and inheritance:
MobilePage: MobilePage responds to a web page that is accessed by a user. It calls ApprovalManager to retrieve and/or process the data.
ApprovalManager: ApprovalManager uses ItemRegistry to map the transaction that the user selected to the data handlers that retrieve and/or process the data for each transaction, then ApprovalManager calls each of the data handlers them to initiate processing of the data.

Different data handlers serve to process the data in accordance with their respective object(s). In this embodiment, each data handler implements a common interface. The ApprovalManager accesses the data handlers through this common interface.

Some data handlers can share functionality because they process data in a similar way. For example, PurchaseOrder, Requisition, JournalEntry and Voucher share some similar processing. A common class ApprovalFrameworkBase 510 is defined to implement common functionality. In some embodiments, and as shown, ApprovalManager comprises one or more handlers (e.g., AggregationHandler) and an item registry (e.g., ItemRegistry), where the one or more handlers interact with an approval processing module base and/or an expense base (e.g., see ExpenseBase 520). Strictly as an illustrative example, the approval processing module base (e.g., ApprovalFrameworkBase 510) corresponds to transactions for at least one of purchase orders, requisitions, journal entries, and vouchers.

FIG. 6 is a screen shot of a home screen 600 as used in systems for processing aggregated transaction approvals using mobile terminals. As an option, one or more instances of home screen 600 or any aspect thereof may be implemented in the context of the architecture and functionality of the embodiments described herein. Also, the home screen 600 or any aspect thereof may be implemented in any desired environment.

FIG. 6 presents an example view of an approvals home screen. This page includes an aggregation view 602 showing multiple types of transactions. The bar chart shows pending amounts for different transaction types including expense reports, journal entries, purchase orders, requisitions, and vouchers. Grouping, prioritization and/or ordering (e.g., prioritization grouping 604, pre-defined ordering, date-wise ordering 606) may be applied to the displayed set of transactions.

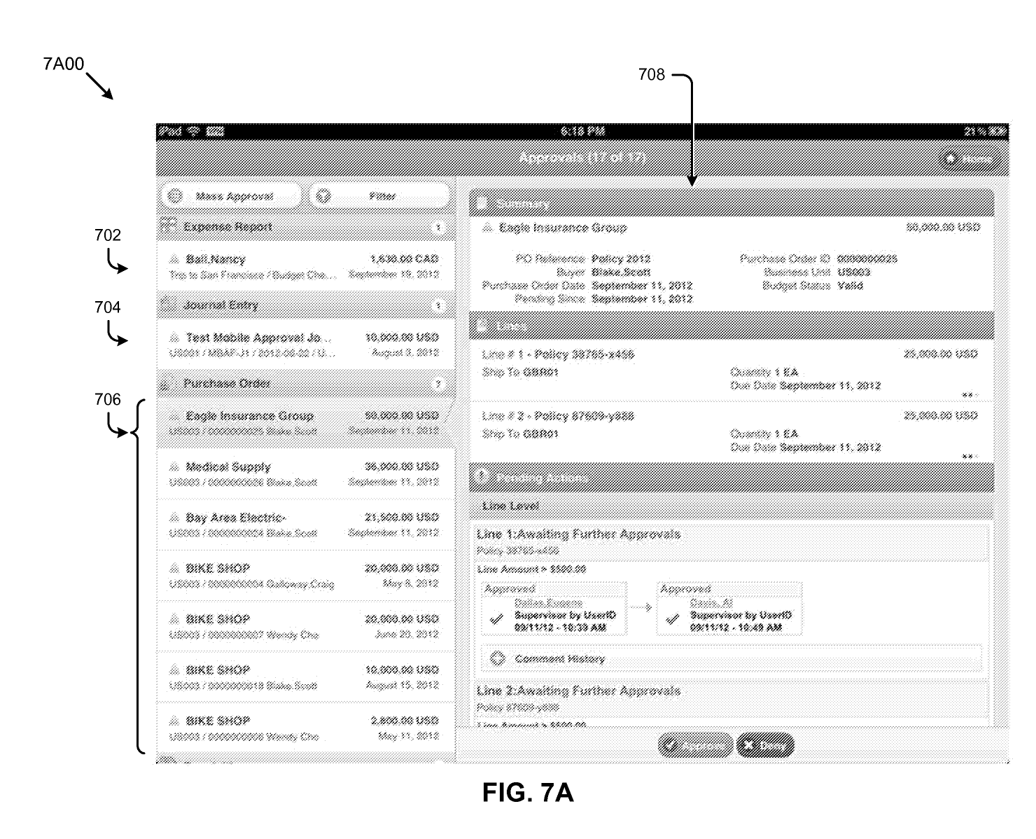

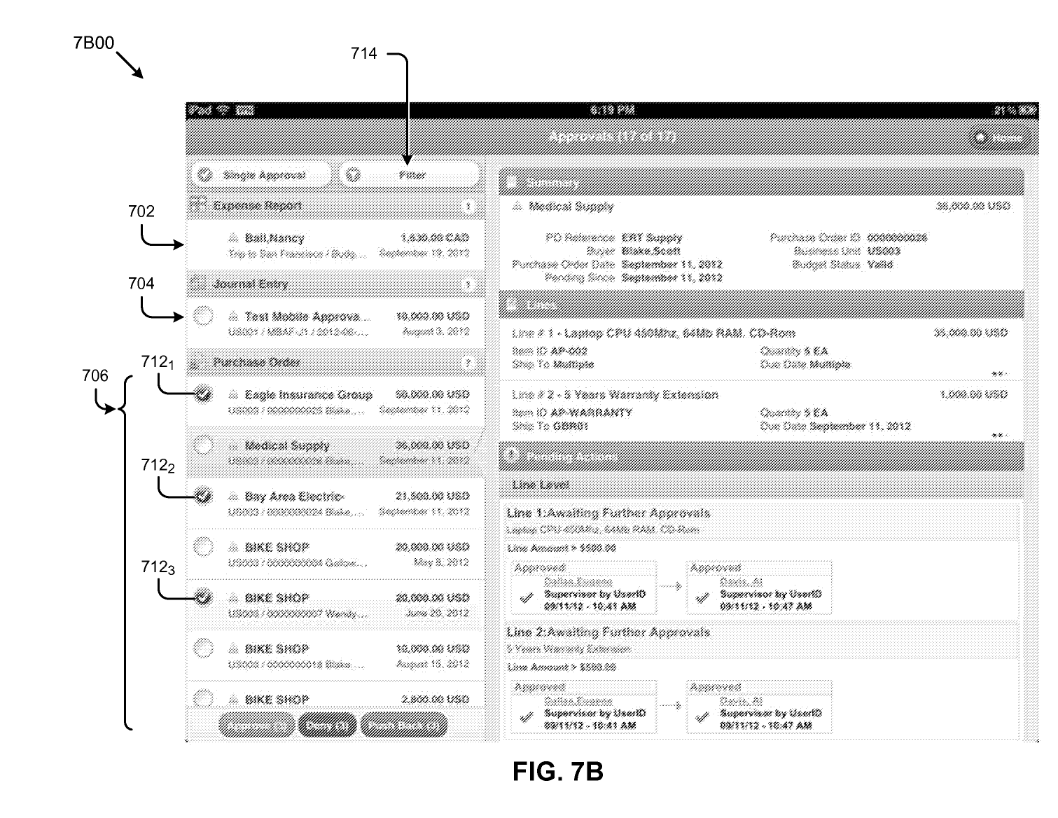

FIG. 7A depicts transaction approval display data displayed as a transaction approval interface 7A00 as used in systems for processing aggregated transaction approvals using mobile terminals. As an option, one or more instances of transaction approval interface 7A00 or any aspect thereof may be implemented in the context of the architecture and functionality of the embodiments described herein. Also, the transaction approval interface 7A00 or any aspect thereof may be implemented in any desired environment.

The transaction approval interface 7A00 shows a listing and details for the listed items, as well as a summary. As shown the listed transaction items on the left side include expense report items 702, journal entry items 704, and purchase order items 706. On the right side, a detail screen display 708 of the selected item (e.g. the first Purchase Order) is shown.

In some cases it is convenient to approve many items in a single approval indication. One possible implementation of an interface to facilitate a mass approval is discussed as follows.

FIG. 7B is a screen shot of an approvals list interface including a mass approval interface 7B00 as used in systems for processing aggregated transaction approvals using mobile terminals. As an option, one or more instances of mass approval interface 7B00 or any aspect thereof may be implemented in the context of the architecture and functionality of the embodiments described herein. Also, the mass approval interface 7B00 or any aspect thereof may be implemented in any desired environment. FIG. 7B shows one implementation of a mass approval mode, where multiple transactions can be selected and approved with the same action.

As shown, each of the transaction items (e.g., purchase order items 706) is decorated with an approval indication widget (e.g., an interactive check box). Any one or more of the approval indication widgets can be individually controlled (e.g., see selected checkbox 712₁, selected checkbox 712₂, selected checkbox 712₃). The transactions corresponding to a selected checkbox can be grouped so as to facilitate a mass approval of all of the indicated transaction approval items. A transaction approval indication can be sent to a server 118 (e.g., using receiving module 113) and can be forwarded to an approval processing module 107 and/or to any one or more enterprise applications.

Some embodiments of an approval module include the use of a filter configurator 714, which can be used to select transactions that are filtered and/or ordered to facilitate presentation of use-selected transactions. The filer can operate based at least in part on priorities, transaction type, and/or date.

In some cases, the presentation of various transaction items (e.g., expense report items 702, journal entry items 704, and purchase order items 706) includes only a portion of the transaction data and data constituent to transactions. As such, an approvable item detail screen can be provided to the user.

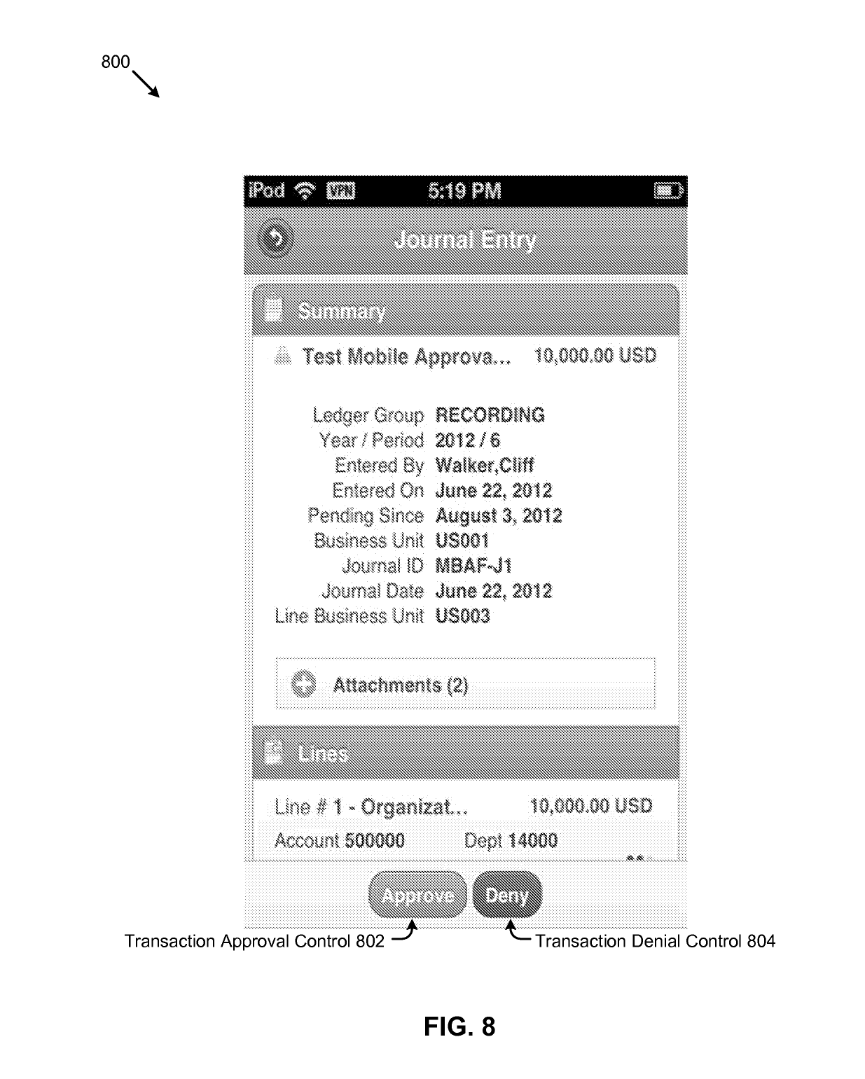

FIG. 8 is a screen shot of an approvable item detail interface 800 as used in systems for processing aggregated transaction approvals using mobile terminals. As an option, one or more instances of approvable item detail interface 800 or any aspect thereof may be implemented in the context of the architecture and functionality of the embodiments described herein. Also, the approvable item detail interface 800 or any aspect thereof may be implemented in any desired environment.

As shown, the approvable item detail interface comprises details of a journal entry transaction and a transaction approval control 802, and a transaction denial control 804. When the approver has selected transactions of other content for approval, the user can interact with an approval submission interface, which approval submission interface is presently discussed.

FIG. 9 is a screen shot of an approval submission interface 900 as used in systems for processing aggregated transaction approvals using mobile terminals. As an option, one or more instances of approval submission interface 900 or any aspect thereof may be implemented in the context of the architecture and functionality of the embodiments described herein.

As shown, the approval submission interface 900 offers the user an option to comment (see comment field 902) and to confirm approval of the selected approvals (see scrolling region 904). The approval submission interface 900 is merely one embodiment, and many variations are possible, for example in a landscape mode, or having additional screen devices, etc.

### ADDITIONAL EMBODIMENTS OF THE DISCLOSURE

### Additional Practical Applications

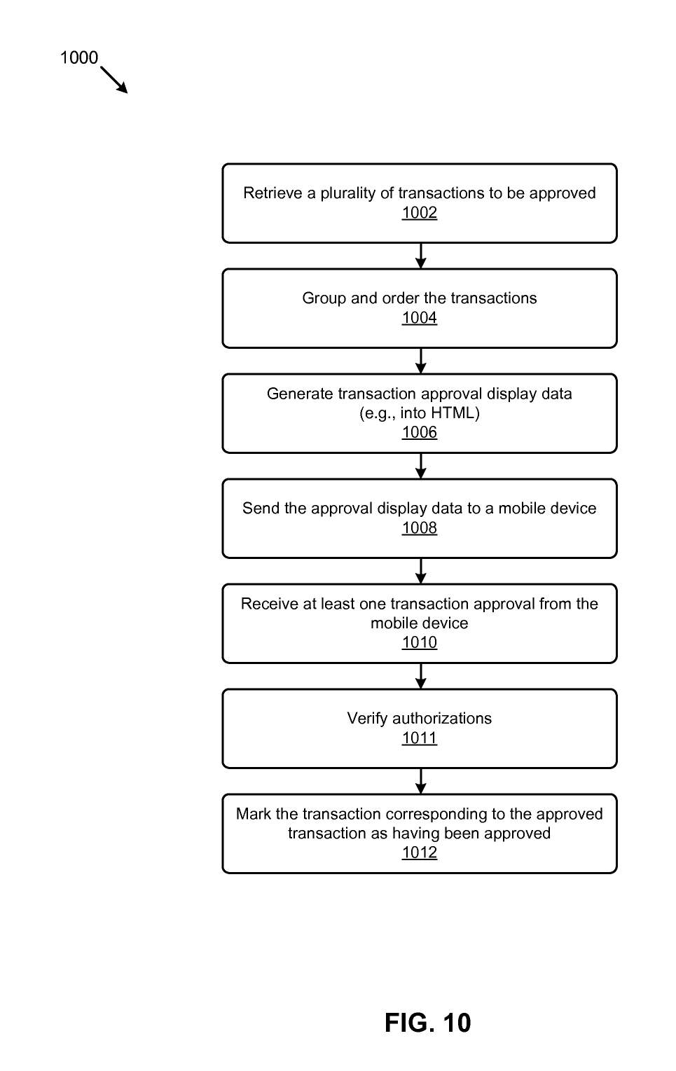

FIG. 10 is a block diagram of a system 1000 for processing aggregated transaction approvals using mobile terminals, according to some embodiments.

The shown approach commences by retrieving transactions to be approved (see operation 1002). Transactions can be grouped and ordered (see operation 1004). The approval information pertaining to the transactions is formatted for delivery and display on the screen of a mobile device (see operation 1006). The display screen of the mobile device can be configured depending on device and/or screen size. In some embodiments, the transaction display data is formatted using HTML for rendering using a browser. The transaction display data including approval indication widgets and/or other information pertaining to the transactions is sent to a mobile device (see operation 1008).

Interaction with the display screen of the mobile device allows a user to approve pending transactions from across different transaction types. The user can select transactions to approve (e.g., using a transaction approval interface). The indicated set of approvals can be received (see operation 1010) and verified (see operation 1011) and the transaction records (e.g., transactions 151) that correspond to the approved transactions can be marked in the data store as approved (see operation 1012).

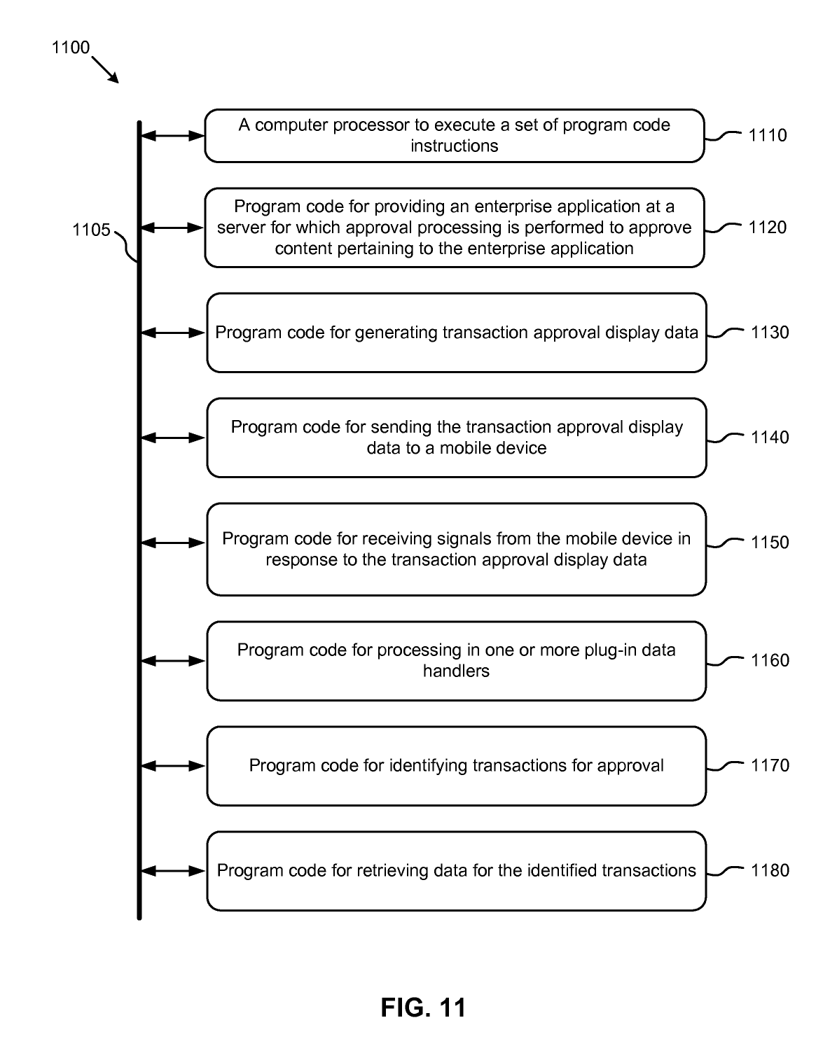

FIG. 11 is a block diagram of a system for processing aggregated transaction approvals using mobile terminals, according to some embodiments. FIG. 11 depicts a block diagram of a system to perform certain functions of a computer system. As an option, the present system 1100 may be implemented in the context of the architecture and functionality of the embodiments described herein. Of course, however, the system 1100 or any operation therein may be carried out in any desired environment. As shown, system 1100 comprises at least one processor and at least one memory, the memory serving to store program instructions corresponding to the operations of the system. As shown, an operation can be implemented in whole or in part using program instructions accessible by a module. The modules are connected to a communication path 1105, and any operation can communicate with other operations over communication path 1105. The modules of the system can, individually or in combination, perform method operations within system 1100. Any operations performed within system 1100 may be performed in any order unless as may be specified in the claims. The embodiment of FIG. 11 implements a portion of a computer system, shown as system 1100, comprising a computer processor to execute a set of program code instructions (see module 1110) and modules for accessing memory to hold program code instructions to perform: providing an enterprise application at a server for which approval processing is performed to approve content pertaining to the enterprise application (see module 1120); generating transaction approval display data (see module 1130); sending the transaction approval display data to a mobile device (see module 1140); and receiving signals from the mobile device in response to the transaction approval display data (see module 1150). Processing can include using one or more plug-in data handlers (see module 1160). A user terminal (e.g., a mobile terminal) may comprise code for identifying transactions for approval (see module 1170), and system 1100 can further comprise program code for retrieving data for the transactions (see module 1180).

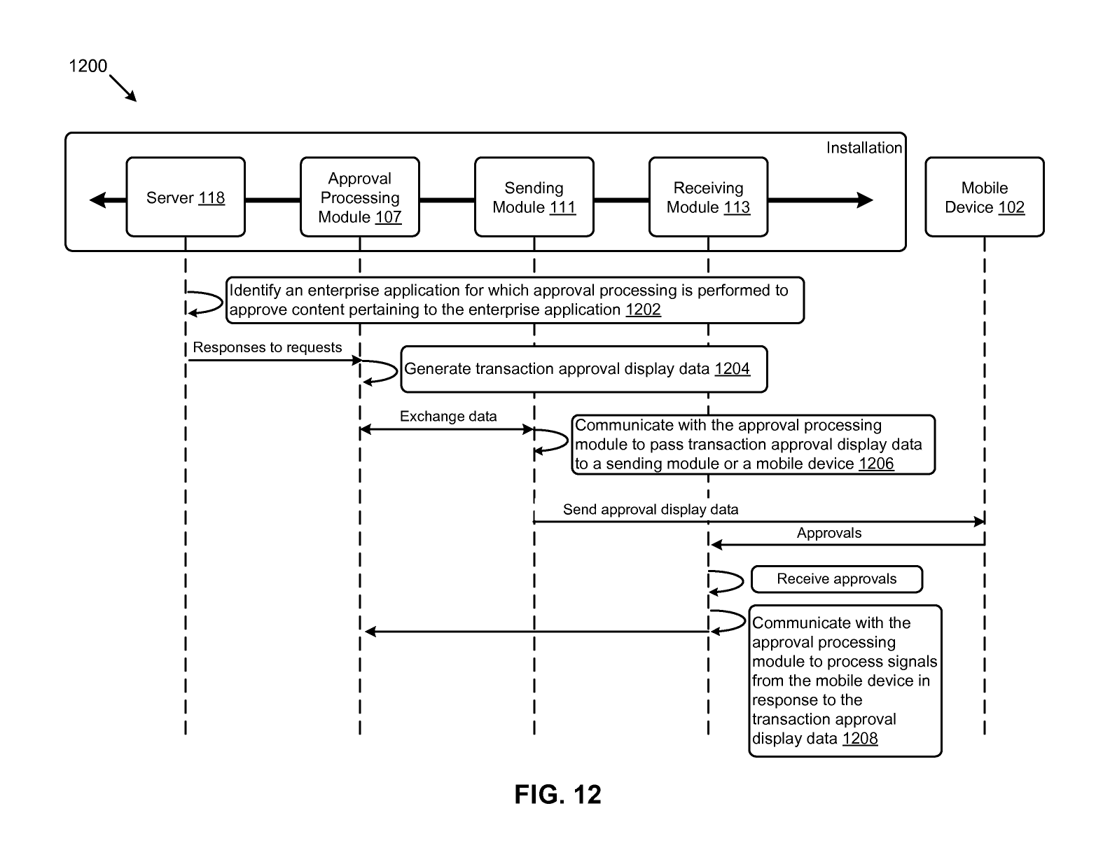

FIG. 12 is a block diagram of a system 1200 for processing aggregated transaction approvals using mobile terminals, according to some embodiments. As shown, a server 118 executes an enterprise application for which approval processing is performed to approve content pertaining to the enterprise application (see operation 1202). An approval processing module 107 serves to generate transaction approval display data (see operation 1204) before preparing the transaction approval display data for delivery to a mobile device 102 (see operation 1206). The transaction approval display data is passed using any known means to a mobile device. The user of the mobile device views the transaction approval display data and sends back approvals in response to the transaction approval display data. The approvals are sent to the approval processing module, and/or to the enterprise application (see operation 1208).

### SYSTEM ARCHITECTURE OVERVIEW

### Additional Practical Applications

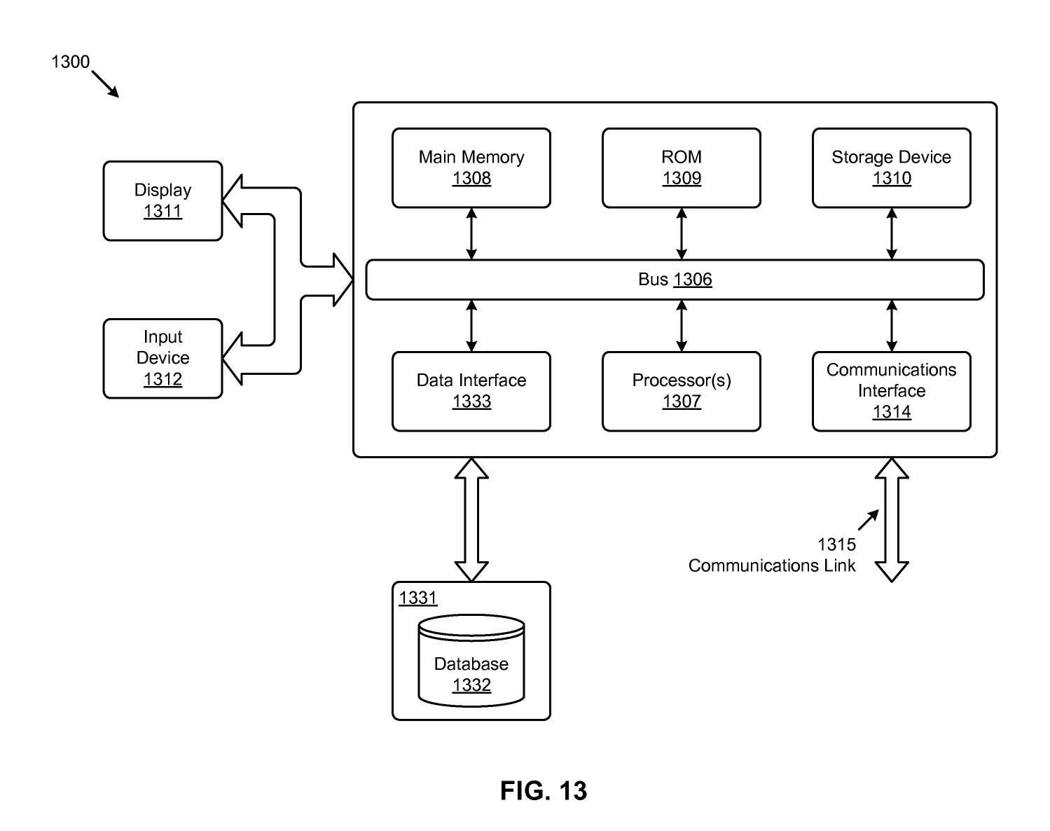

FIG. 13 depicts a block diagram of an instance of a computer system 1300 suitable for implementing an embodiment of the present disclosure. Computer system 1300 includes a bus 1306 or other communication mechanism for communicating information, which interconnects subsystems and devices, such as a processor 1307, a system memory 1308 (e.g., RAM), a static storage device (e.g., ROM 1309), a disk drive 1310 (e.g., magnetic or optical), a data interface 1333, a communication interface 1314 (e.g., modem or Ethernet card), a display 1311 (e.g., CRT or LCD), input devices 1312 (e.g., keyboard, cursor control), and an external data repository 1331.

According to one embodiment of the disclosure, computer system 1300 performs specific operations by processor 1307 executing one or more sequences of one or more instructions contained in system memory 1308. Such instructions may be read into system memory 1308 from another computer readable/usable medium, such as a static storage device or a disk drive 1310. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to processor 1307 for execution. Such a medium may take many forms, including but not limited to, non-volatile media and volatile media. Non-volatile media includes, for example, optical or magnetic disks, such as disk drive 1310. Volatile media includes dynamic memory, such as system memory 1308.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system 1300. According to certain embodiments of the disclosure, two or more computer systems 1300 coupled by a communications link 1315 (e.g., LAN, PTSN, or wireless network) may perform the sequence of instructions required to practice the disclosure in coordination with one another.

Computer system 1300 may transmit and receive messages, data, and instructions, including programs (e.g., application code), through communications link 1315 and communication interface 1314. Received program code may be executed by processor 1307 as it is received, and/or stored in disk drive 1310 or other non-volatile storage for later execution. Computer system 1300 may communicate through a data interface 1333 to a database 1332 on an external data repository 1331. A module as used herein can be implemented using any mix of any portions of the system memory 1308, and any extent of hard-wired circuitry including hard-wired circuitry embodied as a processor 1307.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than restrictive sense.

What is claimed is:

1. A computer implemented method implemented with a processor, comprising:
providing an enterprise application at a server for which approval processing is performed to approve content pertaining to the enterprise application;
generating transaction approval display data;
sending the transaction approval display data to a mobile device; and
receiving signals from the mobile device in response to the transaction approval display data.

2. The method of claim 1 wherein generating transaction approval display data comprises HTML generation.

3. The method of claim 1, further comprising processing in one or more plug-in data handlers.

4. The method of claim 1, in which transaction data is aggregated to obtain approvals for transactions.

5. The method of claim 1, further comprising:
identifying transactions for approval;
retrieving data for the identified transactions; and
generating display data for an interface.

6. The method of claim 5, in which the transactions are identified based upon at least one of, specific users, reviewers, departments, and groups.

7. The method of claim 5, in which data for the transactions pending approval are aggregated together.

8. The method of claim 7, in which the transactions comprise different transaction types.

9. The method of claim 1, in which the approvals correspond to transactions for at least one of, expense reports, journal entries, purchase orders, requisitions, and vouchers.

10. The method of claim 1, in which a mass approval mode is provided.

11. The method of claim 1, in which a mobile display comprises an aggregation view of multiple types of transactions.

12. The method of claim 1, in which filtering is applied to displayed items on a mobile page.

13. The method of claim 1, in which approvals are obtained on a mobile device.

14. The method of claim 1, in which the signals from the mobile device correspond to at least one of, instructions to query and instructions to approve pending transactions.

15. A computer program product embodied in a non-transitory computer readable medium, the computer readable medium having stored thereon a sequence of instructions which, when executed by a processor causes the processor to execute a process, the process comprising:
providing an enterprise application at a server for which approval processing is performed to approve content pertaining to the enterprise application;
generating transaction approval display data;
sending the transaction approval display data to a mobile device; and
receiving signals from the mobile device in response to the transaction approval display data.

16. The computer program product of claim 15 wherein generating transaction approval display data comprises HTML generation.

17. The computer program product of claim 15, further comprising instructions for processing in one or more plug-in data handlers.

18. The computer program product of claim 15, in which transaction data is aggregated to obtain approvals for transactions.

19. The computer program product of claim 15, further comprising instructions for:
identifying transactions for approval;
retrieving data for the identified transactions; and
generating display data for an interface.

20. The computer program product of claim 19, in which the transactions are identified based upon at least one of, specific users, reviewers, departments, and groups.

21. The computer program product of claim 19, in which data for the transactions pending approval are aggregated together.

22. The computer program product of claim 21, in which the transactions comprise different transaction types.

23. The computer program product of claim 15, in which the approvals correspond to transactions for at least one of, expense reports, journal entries, purchase orders, requisitions, and vouchers.

24. The computer program product of claim 15, in which a mass approval mode is provided.

25. The computer program product of claim 15, in which a mobile display comprises an aggregation view of multiple types of transactions.

26. The computer program product of claim 15, in which filtering is applied to displayed items on a mobile page.

27. The computer program product of claim 15, in which approvals are obtained on a mobile device.

28. The computer program product of claim 15, in which the signals from the mobile device correspond to at least one of, instructions to query and instructions to approve pending transactions.

29. A system comprising:
a server executing an enterprise application for which approval processing is performed to approve content pertaining to the enterprise application;
an approval processing module to generate transaction approval display data;
a sending module in communication with the approval processing module to pass transaction approval display data to a second sending module or a mobile device; and
a receiving module in communication with the approval processing module to process signals from the mobile device in response to the transaction approval display data.

30. The system of claim 29, further comprising a data storage unit in communication with the enterprise application.

31. The system of claim 29, further comprising a memory for holding one or more plug-in data handlers.

32. The system of claim 29, in which transaction data is aggregated to obtain approvals for transactions.

33. The system of claim 29, further comprising and execution unit for:
identifying transactions for approval;
retrieving data for the identified transactions; and
generating display data for an interface.

34. The system of claim 33, in which the transactions are identified based upon at least one of, specific users, reviewers, departments, and groups.

35. The system of claim 33, in which data for the transactions pending approval are aggregated together.

36. The system of claim 35, in which the transactions comprise different transaction types.

37. The system of claim 29, in which the approvals correspond to transactions for at least one of, expense reports, journal entries, purchase orders, requisitions, and vouchers.

38. The system of claim 29, in which a mass approval mode is provided.

39. The system of claim 29, in which approvals are obtained on a mobile device.
